(19) United States
(12) Patent Application Publication
(10) Pub. No.: US 2024/0310035 A1
(43) Pub. Date: Sep. 19, 2024

(54) Process and Steam Generating Device for Generating Process Steam

(71) Applicant: Fraunhofer-Gesellschaft zur Forderung der angwandten Forschung e.V., MÜCHEN (DE)

(72) Inventors: Marcus Budt, Essen (DE); Sven Klute, Bochum (DE)

(21) Appl. No.: 18/603,587

(22) Filed: Mar. 13, 2024

(30) Foreign Application Priority Data
Mar. 14, 2023 (DE) 10 2023 106 382.0

(51) Int. Cl. F22B 33/14; C02F 1/20; F22B 1/02; F22D 11/00; C02F 103/02

(52) U.S. Cl. CPC F22B 33/14; C02F 1/20; F22B 1/02; F22D 11/006; C02F 2103/02

(57) ABSTRACT

A method for generating process steam using condensate recycled in the form of feed water is described and illustrated. In order to be able to achieve a higher efficiency with the method, it is proposed that the process steam is delivered to a consumer device (V) to form a condensate by at least partial condensation of the process steam, that the condensate from the consumer device (V) is fed to a feed water treatment for treatment, that feed water from the feed water treatment is separated into a steam phase and a liquid phase in a flash tank, that the liquid phase of the feed water is evaporated in an evaporator to form a raw steam, and that the steam phase of the feed water and the raw steam are compressed in at least one compressor to form process steam.

### CROSS-REFERENCE TO RELATED APPLICATION

This application claims priority to German Patent Application No. 10 2023 106 382.0 filed Mar. 14, 2023, the disclosure of which is hereby incorporated by reference in its entirety.

### BACKGROUND OF THE INVENTION

### Field of the Invention

The invention relates to a method for generating process steam using condensate recycled in the form of feed water. Furthermore, the invention relates to a steam generating device for generating process steam using condensate recycled in the form of feed water according to such a method.

### Description of Related Art

Steam generation equipment is regularly used to generate process steam that can drive a steam turbine or be used to heat an industrial process. Such industrial processes can be chemical processes or other manufacturing processes in which heat is required at certain points or to carry out certain process steps. These can simply be drying processes or the like, for example.

As a rule, steam generating devices comprise one or more steam generators in the form of so-called steam boilers, which are fired with fossil or regenerative fuels. The combustion energy released herewith and the resulting hot flue gas are used to evaporate the feed water supplied to the steam boiler. To industrial steam boilers, feed water is usually fed at overpressure via pipes so that process steam can be continuously and efficiently fed to a connected consumer device at an essentially constant pressure and constant temperature. As previously discussed, the type of consumer device may be vary largely. The process steam is condensed in the consumer device regardless of its respective type, yet with the release of heat. The condensate is usually returned via a recirculation device and fed into a feed water treatment of the steam generating device, in which the condensate is degassed. The feed water produced in this way is then evaporated again in the steam boiler and fed back to the consumer device as process steam.

In order to utilize the energy of the flue gases in the steam generator as effectively as possible and transfer it to the feed water, it is desirable to supply the feed water to the steam generator at the lowest possible temperature. However, there may be other reasons against the temperature falling below certain levels. For example, to avoid corrosion, the feed water should be at a sufficient temperature to prevent the flue gas from falling below the acid dew point of the flue gas. Otherwise, the flue gas leaves the steam generator at a relatively high temperature and therefore with a relatively high amount of unused heat. However, in the event of thermal degassing in the feed water treatment, the feed water is provided at a temperature level of slightly above 100° C. To reduce the feed water temperature after degassing, heat exchangers are known in which the feed water is cooled, for instance, by fresh water which can then be fed to the feed water treatment to compensate for condensate losses. The condensate losses can occur, for example, when part of the condensate is drained off to remove non-volatile impurity substances that accumulate in the water circuit.

A steam generator is generally understood as one that can, in particular, have an economizer for preheating or heating the feed water, an evaporator for evaporating the preheated and/or heated feed water and a superheater for heating the steam to a desired temperature or at least to a temperature above the saturated steam temperature. In some cases, however, the economizer and/or the superheater can be dispensed with. The steam generator may also include a furnace for generating the required heat by burning a fuel. However, this is not necessary. The feed water is preferably fed in counterflow with the heat transfer medium for preheating, heating, evaporation and/or superheating, whereby the heat transfer medium can be a flue gas but does not have to be.

### SUMMARY OF THE INVENTION

Therefore, the present invention is based on the object of designing and further developing the process and the steam generating device of the type mentioned at the beginning and explained in more detail above in such a way that greater efficiency can be achieved.

This problem is solved as described herein by a process for generating process steam using condensate recycled in the form of feed water,
in which the process steam is delivered to a consumer device to form a condensate by at least partial condensation of the process steam,
in which the condensate is fed from the consumer device to a feed water treatment system for treatment,
in which feed water from the feed water treatment system is separated into a steam phase and a liquid phase in a flash tank,
in which the liquid phase of the feed water is evaporated in an evaporator to form a raw steam, and
in which the steam phase of the feed water and the raw steam are compressed in at least one compressor to form process steam.

Said object is further solved as described herein by a steam generating device for generating process steam using condensate recycled in the form of feed water, preferably with a method as described herein, with a flash tank for separating the feed water into a steam phase and a liquid phase, with an evaporator for evaporating the liquid phase of the feed water to form a raw steam, with at least one compressor for compressing the steam phase of the feed water and the raw steam to form process steam, with a delivery device to a consumer device for forming a condensate by condensation of the process steam, with a return device for feeding condensate and with a feed water treatment for treating the condensate to form the feed water.

In terms of process, process steam is thus formed in the steam generating device and delivered to a consumer device in which the heat of the process steam is used and the process steam is consequently condensed. The condensate produced when condensing the process steam in the consumer device can be returned to the steam generating device, where the condensate is then fed to a feed water treatment. The condensate is treated in the feed water treatment, as unwanted quantities of impurity substances could otherwise accumulate in the condensate. The impurity substances are in particular, but not necessarily, gases dissolved in the condensate, which may cause problems when the feed water is subsequently re-evaporated. As an alternative or in addition to dissolved gases, liquids or solids can also be separated in the feed water treatment, if required together with part of the condensate. The loss of condensate that occurs in this way, for example, can be compensated for by adding fresh water to the feed water treatment.

The condensate accordingly treated in the feed water treatment is referred to as feed water and is fed from the feed water treatment into a flash tank in which the pressure of the feed water is reduced. As a result, part of the treated feed water is evaporated and forms a steam phase in the flash tank. The non-evaporated part of the feed water forms the liquid phase in the flash tank. The partial evaporation of the feed water removes heat from the feed water so that the steam phase and the liquid phase of the feed water have a temperature that is significantly lower than the temperature of the feed water in the feed water treatment. The temperature of the feed water in the flash tank can be reduced to such an extent that the liquid phase can be evaporated by a heat source at a low temperature level in an evaporator. For the sake of simplicity, the evaporator can take the form of a heat exchanger, in particular a tube bundle heat exchanger or a plate heat exchanger, whereby the heat source can be formed by a liquid and/or a gas. This may be a process stream whose heat cannot be used in any other sensible way due to the low temperature level. However, the heat of the process stream can be used to evaporate the liquid phase of the feed water, which can be cooled in the flash tank to a specific temperature, in particular below the temperature of the heat source.

By evaporating the liquid phase of the feed water, it can absorb heat that would otherwise not usable or less effectively unusable. However, the resulting raw steam has a temperature level that also prevents the raw steam from being used effectively. For this reason, the raw steam is compressed in at least one compressor, which inevitably leads to heating of the raw steam, which is available as energetically usable process steam when it leaves the compressor.

Also the steam phase of the feed water from the flash tank is fed to at least one compressor in order to raise the pressure level and the temperature level of the steam phase and in this way generate process steam that can be used to generate energy. The steam phase of the feed water from the flash tank and the raw steam from the evaporator can first be combined and then compressed together in at least one compressor. However, the steam phase of the feed water from the flash tank and the raw steam from the evaporator can also be compressed separately in different compressors. Which variant is preferred here can depend, among other things, on the quantities of steam formed in the flash tank and in the evaporator.

In particular for carrying out the process described above, the steam generating device has a flash tank for separating the feed water into a steam phase and a liquid phase. The steam phase is formed in the flash tank by expanding the treated feed water. The remaining liquid phase of the feed water, which has cooled down in the flash tank, is evaporated in an evaporator by heat exchange with a heat source at a temperature level above the temperature of the liquid phase from the flash tank, forming a raw steam. In addition, at least one compressor is provided in which the steam phase from the flash tank and the raw steam from the evaporator are compressed and heated. The steam phase and the raw steam can be compressed at least partially together and/or at least partially separately from each other in one compressor or in several compressors. The at least one compressor is therefore used to form at least one process steam. The steam generating device further comprises a delivery device for delivering the at least one process steam to a consumer device and a return device for feeding condensate from the consumer device into the evaporation device. Finally, a feed water treatment is also provided, which serves to treat the returned condensate before it is evaporated again in the evaporation device and thus to form feed water.

According to the subject matter, all known types of compressors can in principle be considered. In particular, these are turbo compressors, piston compressors and screw compressors.

In the following, the method and the steam generating device are described together without necessarily distinguishing in detail between the method and the steam generating device. However, the person skilled in the art understands from the respective context which features are particularly preferred with respect to the method and the steam generating device.

In a first particularly preferred embodiment of the process, the condensate is at least partially degassed in the feed water treatment. Gases contained in the feed water can damage the steam generator. In particular, oxygen (O2) and/or carbon dioxide (CO2) can pose a problem or be present in large quantities in the condensate of the process steam. Therefore, in many cases, oxygen (O2) and/or carbon dioxide (CO2) is preferably expelled from the condensate in the feed water treatment.

To degas the condensate in the feed water treatment, it can be useful to supply the condensate to the feed water treatment together with a heating steam, regardless of the gases to be expelled. The heating steam heats the condensate, in particular directly. As a result of the high temperature, the gases are expelled from the feed water and preferably removed from the feed water treatment together with the vapor from the heating steam and/or with the evaporated condensate.

In order to make the treatment of the condensate to obtain feed water as well as the heating of the industrial process with process steam energy-efficient, it is advisable for the condensate to be fed to the feed water treatment at a temperature of between 60° C. and 100° C., preferably between 70° C. and 80° C., in particular at least essentially 80° C. The higher the temperature of the condensate, the less heating steam is required to treat it. The higher the temperature of the condensate, the less heating steam is required to treat it. The lower the temperature of the condensate, the greater the amount of heat that can be transferred to the industrial process to be heated. Furthermore, heat losses along the pipe lengths must be taken into account.

Alternatively or additionally, for the same reasons, the condensate can be treated in the feed water treatment at a pressure of between 1 bar and 2 bar, preferably between 1.1 and 1.5 bar, in particular at least essentially 1.2 bar. The lower the pressure, the more heat can be transferred to the industrial process. However, a certain pressure is required to sufficiently degas the condensate and to ensure sufficient expansion of the feed water in the flash tank. For this reason, the temperature of the feed water in the feed water treatment is preferably above 100° C., with little heating steam being required at a temperature between 102° C. and 108° C., in particular at least essentially 105° C. At the same time, a sufficient expansion and temperature reduction can be ensured in the flash tank.

In order to cool the liquid phase of the feed water sufficiently in an overall economical manner, it is generally advisable to operate the flash tank at an absolute pressure of between 0.07 bar and 0.9 bar. The lower the pressure, the colder the heat sources that can be used in the evaporator to evaporate the liquid phase of the feed water. It may be particularly preferable for the flash tank to be operated at a pressure of between 0.12 bar and 0.8 bar, although in many cases a pressure of at least essentially 0.2 bar or 0.6 bar will be a fairly good compromise. For the reasons previously mentioned in connection with the pressure and in view of the fact that the pressure and the temperature in the flash tank depend on one another, it will be suitable, alternatively or additionally, if the flash tank is operated at a temperature between 40° C. and 96° C., preferably between 50° C. and 93.5° C. Evaporation of the liquid phase of the feed water at a low temperature level will in many cases be economically feasible at a temperature of at least essentially 60° C. or 85.9° C.

In order to reduce the pressure in the flash tank to a pressure level that is below the pressure level in the feed water treatment and, in particular, below the ambient pressure, it is advisable for the sake of simplicity for the compressor in the flash tank to draw a corresponding negative pressure. The pressure in the flash tank must be set so low that it is at least below the pressure in the feed water treatment. Otherwise, partial evaporation of the feed water with simultaneous cooling of the same in the flash tank cannot be ensured.

Irrespective of this, it is useful for many applications if the compressor generates process steam at a temperature of between 100° C. and 450° C. In these cases, the aforementioned advantages of the process also come into play. This applies all the more if the temperature of the process steam is between 100° C. and 250° C. A good compromise that allows efficient use of the steam generating device will in many cases be a process steam temperature of at least essentially 200° C.

The heating steam can be provided to the feed water treatment for the purpose of, in particular direct, heating of the condensate in a simple and economical way using at least one process steam and/or the raw steam. An external heat source is then not required. This is particularly the case if the at least one process steam and/or the at least one raw steam is at least partially throttled via a throttle to form the heating steam.

In many cases in industrial systems, especially in industrial processes, fluids are produced at such a low temperature level that the heat contained in the fluids can hardly be utilized in a sensible manner. It therefore makes sense to evaporate the liquid phase of the feed water in the evaporator by heat exchange with a heat source, in particular in the form of a heat transfer medium, whose temperature level is above the temperature level of the liquid phase in the flash tank and below the temperature level of the feed water in the feed water treatment. In particular, the treated feed water, media from biomass plants and/or heat pumps and/or a geothermal fluid are suitable heat transfer media. In principle, waste heat streams, which in particular have not generally been usable in the past, can be utilized in a useful way. A geothermal fluid is understood to be a fluid whose heat is provided using geothermal energy in particular. The geothermal fluid can be either naturally occurring underground water or a medium subsequently introduced from above ground. In both cases, the medium is heated by the underground reservoir and thermally utilized on the surface and cooled in the process. Heating can take place directly as the fluid flows through the rock or indirectly via a closed, separate system. The use of a geothermal fluid to evaporate the liquid phase of the feed water can be particularly preferable because, although geothermal heat reservoirs are available in many places, these may only have relatively low temperature levels. An evaporation of the feed water would otherwise only be possible by heating the geothermal fluid. However, when using a geothermal fluid, the heat to be transferred is limited, as the geothermal fluid can only be cooled down to almost the feed water temperature.

Geothermal fluids that have been heated to a temperature of at least 40° C., preferably at least 60° C., by means of geothermal energy are therefore particularly suitable. Compared to other methods, such geothermal fluids can be used very efficiently and economically to generate process steam. This is particularly the case for geothermal fluids with a temperature of at least 80° C. The geothermal fluid is also preferably a liquid due to the heat transport.

If required, in addition to the process steam provided by the at least one compressor, process steam can also be generated in the evaporation device using at least one steam boiler and/or at least one waste heat boiler. A steam boiler typically comprises an economizer for preheating or heating the feed water, an evaporator for evaporating the preheated and/or heated feed water and a superheater for heating the steam to a desired temperature or at least to a temperature above the saturated steam temperature. In some cases, however, the economizer and/or the superheater can be dispensed with. The steam boiler is also fired by a furnace in which fuel is burned to form a flue gas. The feed water is preferably fed in counterflow with the flue gas for preheating, heating, evaporation and/or superheating. An economizer for preheating or heating the feed water, an evaporator for evaporating the preheated and/or heated feed water and a superheater for heating the steam to a desired temperature or at least to a temperature above the saturated steam temperature can also be provided in a waste heat boiler. However, a waste heat boiler is not heated like a steam boiler with flue gas generated for the purpose of operating the steam boiler, but with a hot exhaust gas or another hot fluid from an upstream process, which is generated there anyway, for example as a waste heat transporting waste heat stream.

Part of the feed water treated in the feed water treatment can be fed to the steam boiler. However, in order to utilize the heat of the flue gas, which heats the feed water in the steam boiler, as completely as possible, it is in particular useful if part of the liquid phase of the feed water from the flash tank is fed to the steam boiler for evaporation. The liquid phase cooled in the flash tank can therefore extract more heat from the flue gas in the steam boiler, especially if the flue gas and the liquid phase of the feed water from the flash tank are fed in counterflow.

The process steam formed in the steam boiler can then be combined with the process steam formed in the at least one compressor and then delivered to the consumer device via the delivery device. However, the process steam formed by means of the steam boiler and the process steam formed by means of the at least one compressor can also be delivered separately to the consumer device. However, each of the aforementioned process steams can also be at least partially throttled via a throttle and then fed to the feed water treatment as heating steam. It is generally advisable for the process steam formed in the at least one steam boiler to have a temperature of at least 140° C., preferably at least 150° C., in particular at least 160° C., so that it can be used appropriately in a consumer device of the industrial plant. Alternatively or additionally, the temperature of the process steam generated in the at least one steam boiler is less than 450° C., preferably less than 250° C. and in particular less than 200° C., in order to be able to provide the heat for a consumer device particularly economically.

In a first embodiment of the steam generating device, which is particularly preferred, the feed water treatment has a heating steam supply line for supplying heating steam, via which heating steam can be supplied for heating the condensate and treating the condensate in the feed water treatment. Treatment and heating are particularly simple and effective if the feed water treatment is designed to heat the condensate directly with the heating steam. Alternatively or additionally, the feed water treatment can be equipped with a vapor discharge, via which gases expelled from the condensate in the feed water treatment can be discharged. This can be done together with steam, i.e. vapor, especially if the condensate is heated directly with the heating steam. However, this is not mandatory.

Irrespective of this, a throttle can be assigned to the heating steam supply line to form heating steam by throttling process steam. In this way, a sufficient quantity of heating steam can be supplied to the feed water treatment easily and economically.

To simplify the equipment of the steam generating device, it may also be advisable to provide a merger for combining the steam phase of the feed water from the flash tank and the raw steam from the evaporator. The steam phase and the raw steam can then be fed together to the at least one compressor to generate process steam.

The evaporator can have a supply line for condensate to evaporate the liquid phase of the feed water by heat exchange with the condensate supplied via the supply line. The condensate can then also be used simply and effectively to evaporate the liquid phase in the evaporator. Alternatively or additionally, the evaporator has a supply line for feed water for evaporating the liquid phase of the feed water by heat exchange with the feed water supplied via the supply line. The higher temperature level of the feed water compared to the condensate can then be utilized. However, the evaporator can also have a feed line for geothermal fluid, as already defined above. The geothermal fluid can then be used energetically to evaporate the liquid phase of the feed water from the flash tank if the temperature level is sufficiently higher than the temperature level of the liquid phase of the feed water from the flash tank.

The use of a geothermal fluid to evaporate the liquid phase of the feed water can be particularly preferable because, although geothermal heat reservoirs are available in many locations, these only have relatively low temperature levels. The temperature levels are usually, especially significantly, below 130° C. Under economic conditions, the heat reservoirs are therefore not suitable for generating process steam using other methods, or only to a very limited extent.

Geothermal fluids that have been heated to a temperature of at least 40° C., preferably at least 60° C., by means of geothermal energy are therefore particularly suitable. Such geothermal fluids can be used very efficiently and economically to generate process steam compared to other methods. This is particularly the case for geothermal fluids with a temperature of at least 80° C. The geothermal fluid is also preferably a liquid due to the heat transport.

### BRIEF DESCRIPTION OF THE DRAWINGS

In the following, the invention is explained in more detail with the aid of a drawing showing only an embodiment. In the drawing show

FIG. 1 a schematic view of an industrial plant for carrying out an industrial process with a steam generating device according to the invention,

FIG. 2 the steam generating device from FIG. 1 in a schematic detail view and

FIG. 3 schematic detailed view of an alternative steam generating device.

### DESCRIPTION OF THE INVENTION

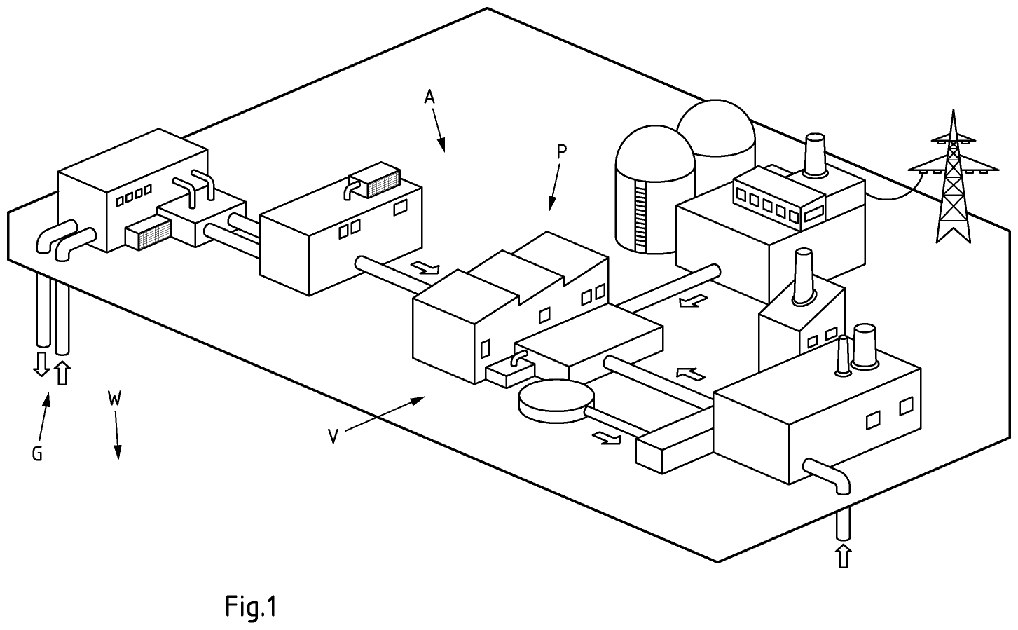

In FIG. 1 an example of an industrial plant A for carrying out an industrial process P is shown. The illustrated and in this respect preferred industrial plant A is a paper production plant in which the industrial process P of paper production is carried out. Alternatively, however, in connection with the invention, many other industrial plants A for carrying out different industrial processes P could also be considered, the industrial processes P being in particular those which have a non-neglectable heat demand. Paper production is characterized by a particularly high heat requirement, since paper production is in principle quite energy-intensive. The industrial plant A is partly heated using geothermal energy. A geothermal fluid G is pumped from an underground reservoir W, in which the geothermal fluid G has absorbed heat. After thermal utilization in the industrial plant A, the geothermal fluid G is returned to the underground reservoir. Thermal utilization is understood to mean the release of heat in a heat exchanger in industrial plant A. The geothermal fluid G, which is referred to as such in the present case because it obtains its heat at least partially from geothermal energy, can then be used to heat the industrial process P in the industrial plant A. However, it is conceivable that the geothermal fluid first transfers some of its heat to a transport fluid, which is then used thermally in the industrial plant A instead of the geothermal fluid itself. Consequently, when the transport fluid is used, the heat is indirectly transferred from the geothermal fluid to the industrial plant A.

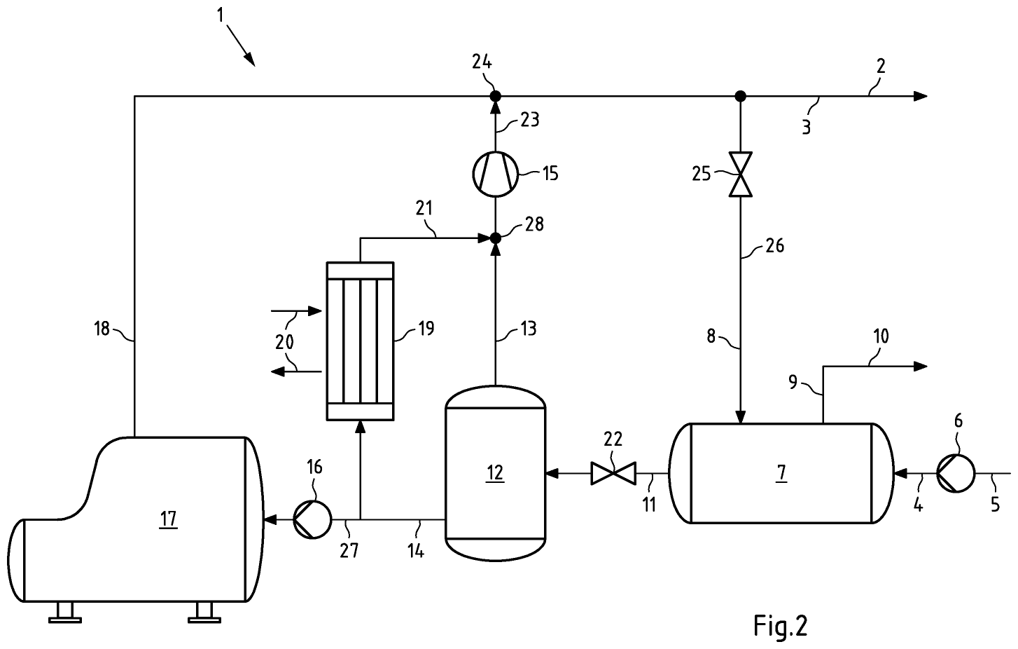

FIG. 2 shows a steam generating device 1 that provides the required heat to a consumer device V of the industrial plant A via a delivery device 2. The heat is used in the form of process steam 3 in the industrial papermaking process P. By using the process steam 3 as a heat source in the corresponding consumer device V of the industrial process P, the process steam 3 is at least partially condensed and the resulting condensate 4 is returned to the steam generating device 1 via a return device 5. The process steam 3 or the condensate 4 is thus at least essentially circulated, albeit in different aggregate states. In the steam generating device 1 shown and preferred in this respect, the delivery device 2 and the return device 5 are designed in the form of a line, specifically a delivery line and a return line. The consumer device V is not shown in FIG. 2, as the specific design of the consumer device V is of no particular significance according to the subject matter.

The condensate 4 returned via the return device 5 is fed via a condensate pump 6 into a feed water treatment 7, where the condensate 4 is heated by means of direct heat exchange with heating steam 8, which is also supplied, in this case from 80° C. to 105° C. The pressure in the feed water treatment 7 is such that a steam phase 9 prevails in the feed water treatment 7, into which gases dissolved in the condensate, in particular oxygen (O₂) and carbon dioxide (CO₂), are expelled. The steam phase 9 is discharged together with the expelled gases via a vapor discharge 10. A suitably treated condensate 4 in the form of feed water 11 remains in the feed water treatment 7. The feed water 11 is delivery from the feed water treatment 7 to a flash tank 12, in which the feed water 11 is expanded in such a way that some of the treated feed water 11 evaporates in the flash tank 12, thereby cooling the feed water 11. In this way, a steam phase 13 of the feed water 11 and a liquid phase 14 of the feed water 11 are formed in the flash tank 12, both of which have a significantly lower temperature than the treated feed water 11 in the feed water treatment 7.

In the illustrated and in this respect preferred steam generating device 1, a negative pressure is created in the flash tank 12 by means of a compressor 15, whereby the flash tank 12 is accordingly located on the suction side of the compressor 15. The pressure in the flash tank 12 is not only below the pressure in the feed water treatment 7, but also below the ambient pressure. It is therefore an absolute pressure of less than 1 bar. The liquid phase 14 of the feed water 11 remaining in the flash tank 12 is then pumped by means of a feed water pump 16 in a return line 27 into a steam boiler 17, in which the feed water 11 is evaporated in a manner known per se. Of course, two or more steam boilers 17 can also be provided, which are then preferably operated in parallel.

A fuel is burned in the steam boiler 17 to form a flue gas. The flue gas is fed along pipes in which the feed water 11 is fed in counterflow to the flue gas and in this way is first heated and then evaporated and, if necessary, superheated. The feed water 11 is under an absolute overpressure, so that the feed water 11 is converted into a process steam 18 in the steam generator 17, which can be used as a heat source for heating the industrial process P in the consumer device V.

The liquid phase 14 of the feed water from the flash tank 12 is delivered to an evaporator 19, in which the liquid phase 14 is evaporated by heat exchange with a heat transfer medium 20 and thus forms a raw steam 21. The heat transfer medium 20 is preferably formed from a geothermal fluid, another waste heat flow, feed water and/or a heat transfer medium from a biomass plant and/or a heat pump in the pressurization device shown and preferred in this respect.

The steam phase 13 of the feed water 11 formed in the flash tank 12 as a result of the expansion of the treated feed water 11 via a throttle 22 is brought together with the raw steam in a merger 28. The steam composed of the raw steam 21 and the steam phase 13 of the feed water 11 is then compressed in the compressor 15, whereby the steam is not only compressed but also heated, so that the compressor forms a further process steam 23, which is combined with the process steam 18 from the steam boiler 17 in the illustrated and in this respect preferred pressure generating device via a merger 24. The process steam 18 from the steam boiler 17 and the process steam 23 from the compressor 15 have approximately the same pressure in the illustrated and in this respect preferred method. The temperatures can also be approximately the same. A part of the correspondingly combined process steam 3 can be fed via a throttle 25 and a heating steam supply line 26 in the form of heating steam 8 into the feed water treatment 7 in order to heat the condensate 4 therein. The part of the process steam 3 not required for the formation of heating steam 8 is then delivered via the delivery device 2 in the form of a delivery line to the consumer device V, before the condensed process steam 3 is later returned to the steam generating device 1 as condensate 4 via the return device.

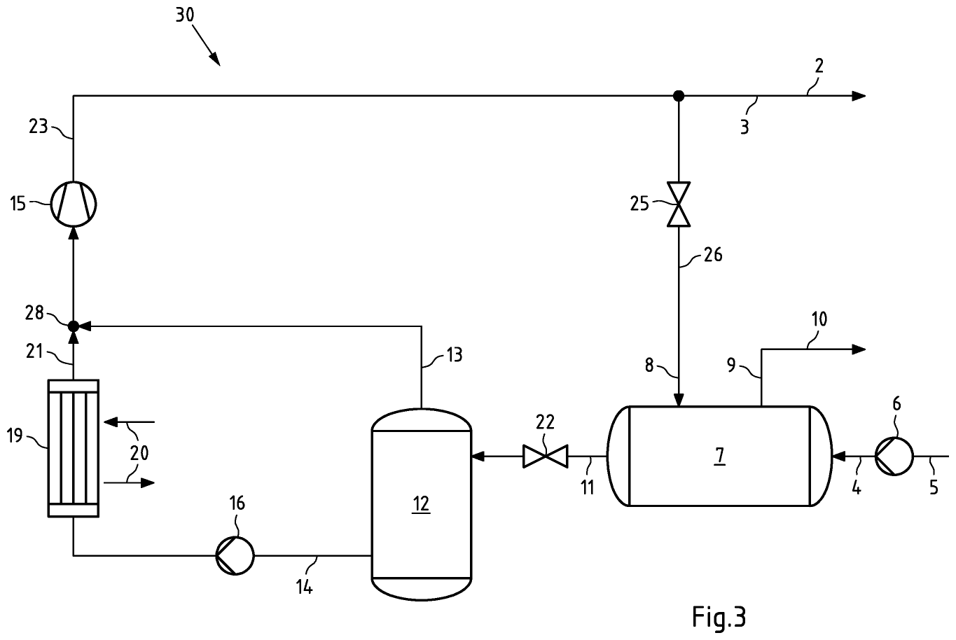

An alternative steam generating device 30 is shown in FIG. 3, which differs from the steam generating device 1 of FIG. 2 in that the return line 27, the steam boiler 17, the process steam 18 generated in the steam boiler 17 and the merger 24 of the process steam 18 with the process steam 23 generated in the compressor 15 have been dispensed with. The process steam 3 of the steam generating device 30 is thus formed exclusively via the compressor 15, although in principle several compressors 15 could also be provided. In such a case, it could also be provided that the steam phase 13 of the feed water 11 from the flash tank 12 is compressed in at least one compressor 15 and the raw steam 21 is compressed in at least one other compressor 15 independently of each other, even if this would be more complex in terms of equipment, for example if a very large amount of raw steam 21 and a very large mass flow of steam phase 13 of the feed water 11 is produced or if different pressure levels/steam networks are to be supplied with process steam.

### LIST OF REFERENCE SYMBOLS

1 Steam generating device
2 Delivery device
3 Process steam
4 Condensate
5 Return device
6 Condensate pump
7 Feed water treatment
8 Heating steam
9 Vapor phase
10 Vapor discharge
11 Feed water
12 Flash tank
13 Vapor phase
14 Liquid phase
15 Compressor
16 Feed water pump
17 Steam boiler
18 Process steam steam boiler
19 Evaporator
20 Heat transfer medium
21 Raw steam
22 Throttle
23 Process steam compressor
24 Merger
25 Throttle
26 Heating steam supply line
27 Return line
28 Merger
30 Steam generating device
A Industrial plant
G Geothermal fluid
P Industrial process
V Consumer facility
W Heat reservoir

1. A method for generating process steam using condensate recycled in the form of feed water,
in which the process steam is delivered to a consumer device (V) to form a condensate by at least partial condensation of the process steam,
in which the condensate is fed from the consumer device (V) to a feed water treatment system for treatment,
in which feed water from the feed water treatment system is separated into a steam phase and a liquid phase in a flash tank,
in which the liquid phase of the feed water is evaporated in an evaporator to form a raw steam, and
in which the steam phase of the feed water and the raw steam are compressed in at least one compressor to form process steam.

2. The method according to claim 1,
in which the condensate is at least partially degassed in the feed water treatment to form feed water, in particular by separating off oxygen (O₂) and/or carbon dioxide (CO₂), and
in which, preferably, the condensate is fed to the feed water treatment system together with a heating steam for, in particular, direct heating of the condensate.

3. The method according to claim 1,
in which the condensate is fed to the feed water treatment system at a temperature of between 60° and 100° C., preferably between 70° C. and 80° C., in particular of at least substantially 80° C., and/or
in which the condensate is degassed in the feed water treatment system at a pressure of between 1 bar and 2 bar, preferably between 1.1 and 1.5 bar, in particular of at least essentially 1.2 bar and/or at a temperature of greater than 100° C., preferably between 102° C. and 108° C., in particular of at least essentially 105° C.

4. The method according to claim 1,
in which the flash tank is operated at a pressure of between 0.07 bar and 0.9 bar, preferably between 0.12 bar and 0.8 bar, in particular of at least essentially 0.2 bar or 0.6 bar, and/or
in which the flash tank is operated at a temperature of between 40° C. and 96° C., preferably between 50° C. and 93.5° C., in particular of at least substantially 60° C. or 85.9° C.

5. The method according to claim 1,
in which the compressor draws a negative pressure in the flash tank at least in comparison with the pressure in the feed water treatment system and/or
in which the at least one compressor generates a process steam at a temperature of between 100° C. and 450° C., preferably between 100° C. and 250° C., in particular at least substantially 200° C.

6. The method according to claim 1,
in which the heating steam of the feed water treatment is at least partially provided by a process steam and/or raw steam, in particular throttled via a throttle.

7. The method according to claim 1,
in which the liquid phase of the feed water is evaporated in the evaporator by heat exchange with a heat transfer medium, in particular feed water, heat flows from biomass plants and/or heat pumps, waste heat flows, and/or geothermal fluid (G), and
in which, preferably, the geothermal fluid (G) has a temperature of at least 40° C., preferably at least 60° C., in particular at least 80° C.

8. The method according to claim 1,
in which the feed water, in particular the liquid phase of the feed water from the flash tank, is partially fed to at least one steam boiler and is evaporated in the at least one steam boiler to form a process steam, and
in which, preferably, the process steam from the at least one steam boiler and the process steam from the at least one compressor are at least partially combined and delivered to the consumer device (V) via the delivery device.

9. A steam generating device for generating process steam using condensate recycled in the form of feed water, preferably with a method according to claim 1, with a flash tank for separating the feed water into a steam phase and a liquid phase, with an evaporator for evaporating the liquid phase of the feed water to form a raw steam, with at least one compressor for compressing the steam phase of the feed water and the raw steam to form process steam, with a delivery device to a consumer device (V) for forming a condensate by condensation of the process steam, with a return device for supplying condensate and with a feed water treatment device for treating the condensate to form the feed water.

10. The steam generating device according to claim 9, wherein
the feed water treatment has a heating steam supply line for heating the condensate, in particular directly, and/or a vapor discharge line for discharging gas expelled from the condensate and that, preferably, the heating steam supply line is assigned a throttle for forming heating steam by throttling of process steam.

11. The steam generating device according to claim 9, wherein
a merging means is provided for the steam phase of the feed water and the raw steam and that, preferably, at least one compressor is provided for jointly compressing the steam phase of the feed water and the raw steam after the merging means.

12. The steam generating device according to claim 9, wherein
the evaporator has a supply line for condensate for evaporating the liquid phase of the feed water and is configured for evaporating the liquid phase of the feed water by heat exchange with the condensate supplied via the supply line and/or that the evaporator has a supply line for feed water for evaporating the liquid phase of the feed water and is configured for evaporating the liquid phase of the feed water by heat exchange with the feed water supplied via the supply line and/or that the evaporator has in supply line for feed water for evaporating the liquid phase of the feed water by heat exchange with the feed water supplied via the supply line and/or that the evaporator has a supply line for geothermal fluid (G) for evaporating the liquid phase of the feed water and is configured for evaporating the liquid phase of the feed water by heat exchange with the geothermal fluid (G) supplied via the supply line.

13. The steam generating device according to claim 9, wherein
the geothermal fluid (G) has a temperature of at least 40° C., preferably at least 60° C., in particular at least 80° C.
